(19) United States
(12) Patent Application Publication
(10) Pub. No.: US 2014/0075699 A1
(43) Pub. Date: Mar. 20, 2014

(54) Thermochromic Foam Cleaning Pad and Process for Making the Same

(71) Applicant: Aaron C. Krause, Voorhees, NJ (US)

(72) Inventor: Aaron C. Krause, Voorhees, NJ (US)

(21) Appl. No.: 13/617,762

(22) Filed: Sep. 14, 2012

(51) Int. Cl. A47K 7/02; B29C 44/04

(52) U.S. Cl. 15/209.1; 264/51

(57) ABSTRACT

The thermochromic foam cleaning pad of the invention is an artificial sponge made from a foam material that changes firmness or rigidity based on the temperature thereof. The foam also includes thermochromic additives therein that change the color of the foam based on the temperature. This provides a visual indication of the temperature of the foam.

### BACKGROUND OF THE INVENTION

The present invention is directed toward a foam cleaning pad that can be used for cleaning a person's hands, for cleaning dishes or for substantially any other cleaning purpose. As will be seen, the pad of the present invention has significant advantages over existing pads.

Artificial sponges made from various foamable plastics have been on the market for many years. These include both open cell and closed cell products that have been molded, extruded or otherwise formed into various shapes for numerous different purposes. In particular, artificial sponges have been used for many years for use as cleaning devices for cleaning dishes or tables or substantially any other products or services.

Several years ago, a product was introduced into the market which was originally specifically designed for cleaning a person's fingers. That product was sold under the trademark SCRUB DADDY, and is shown in U.S. Design Pat. No. D571,515, the subject matter of which is incorporated herein by reference.

When it became apparent that the original SCRUB DADDY product could be used for purposes other than cleaning a person's hands, it was modified to include a slot which resembled a person's mouth. This made the device useful for cleaning forks and spoons and other similar eating utensils. That revised design is the subject of pending U.S. Design patent application Ser. No. 29/395,019, filed on Nov. 14, 2011. Again, the subject matter of this pending design application is incorporated herein by reference. That design is also shown in FIGS. 1 and 2 that form part of the present application.

A further modification was also made to the SCRUB DADDY product which made it even more useful. The product has been made from a foam material that changes firmness or rigidity based on the temperature thereof. That is, when the SCRUB DADDY is used in hot water to wash dishes or the like, it is relatively soft. However, in cold water, the sponge becomes relatively rigid and is useful to scrub debris from dishes or countertops or from a person's hands.

There are situations when it may be important to know whether the sponge is relatively soft or whether it is firm and rigid. To now, this could not be determined without actually manually feeling the sponge. Unfortunately, this could create a somewhat unsafe situation since a person could burn his or her hands while reaching into very hot water to check the condition of the sponge.

A need exists, therefore, for a foam cleaning pad that changes in firmness or rigidity at different temperatures and which also provides a visual indication of the firmness of the sponge.

### SUMMARY OF THE INVENTION

The present invention is designed to overcome the deficiencies of the prior art discussed above. It is an object of the present invention to provide an artificial sponge that changes in firmness or rigidity based on the temperature thereof and which also provides a visual indication of the firmness of the sponge.

In accordance with the illustrative embodiments demonstrating features and advantages of the present invention, there is provided an artificial cleaning sponge made from a foam material that changes firmness or rigidity based on the temperature thereof. The foam also includes thermochromic additives therein that change the color of the foam based on the temperature. This provides a visual indication of the temperature of the foam.

Other objects, features, and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawings one form which is presently preferred; it being understood that the invention is not intended to be limited to the precise arrangements and instrumentalities shown.

FIG. 1 is a front perspective view of the thermochromic cleaning pad of the present invention, and

FIG. 2 is a front elevational view thereof.

### DETAILED DESCRIPTION OF THE PREFERRED EMBODIMENT

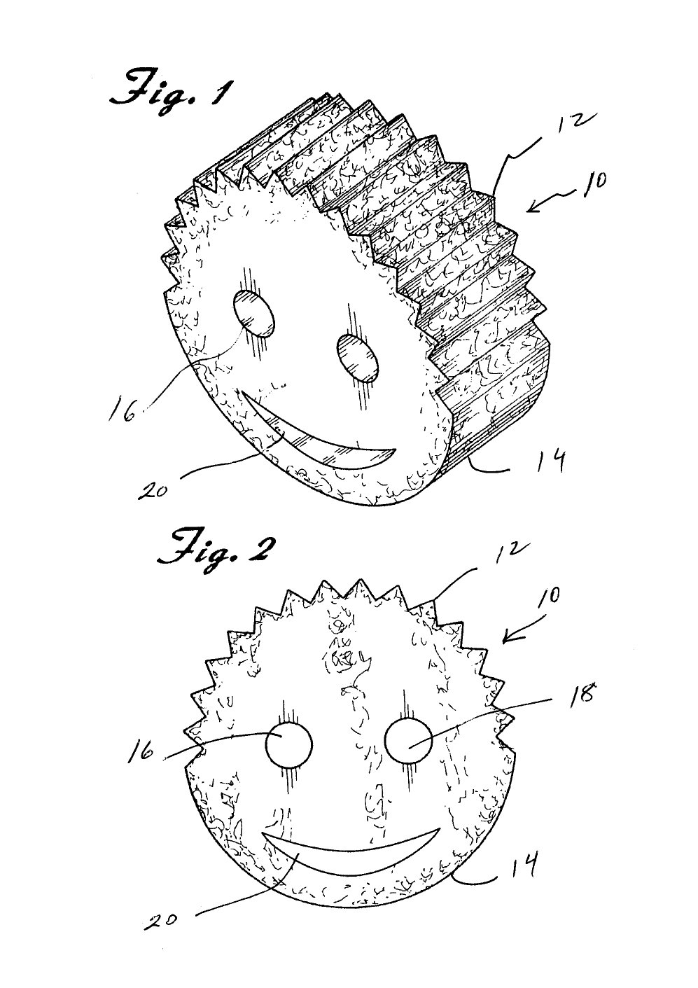

Referring now to the several drawings in detail wherein like reference numerals have been used throughout the various figures to designate like elements, there is shown in FIGS. 1 and 2 a thermochromic foam cleaning pad constructed in accordance with the principles of the present invention and designated generally as 10. In the preferred embodiment, the cleaning pad or sponge 10 is generally round and cylindrically-shaped and may have the appearance of a comical face. It should be understood, however, that this is by way of example only and that other shapes and appearances could obviously made.

While the sponge pad 10 may resemble a comical face, the various parts thereof are actually very functional. For example, the zig-zag or triangularly-shaped peaks 12 at the top of the sponge that may resemble hair can provide a more abrasive or scrubbing surface than the smoother bottom 14. The openings 16 and 18 that resemble eyes are useful for cleaning a person's fingers. That is, a person can insert his or her fingers into the openings to scrub them clean.

Similarly, the relatively narrow and curved opening 20 that resembles a mouth is useful for cleaning spoons or forks or other silverware or similar eating utensils. Again, all of the foregoing is by way of example only.

As explained above, the sponge 10 has the characteristics of being relatively rigid at cold temperatures, such as 50-60 degrees F., for example, but becomes softened at elevated temperatures above 100 degrees F., for example. As is known in the art, this is accomplished by utilizing base thermoplastic materials such as polyurethanes, polyesters and related compositions and mixing them with thermoplastic materials that may have soft or putty-like characteristics at different temperatures. Examples are capero-lactones and related thermoplastics such as sold under the names Protoplast or Draco. As is also well known in the art, polymer compositions can be further cross-linked for increased temperature settings, durability, structural strength and the like. In addition, various additives can be employed depending on the use to which the sponge pad is to be used.

A foamed sponge made from the materials described above will have the characteristics of being relatively firm or rigid at cold temperatures but relatively soft at elevated temperatures. The firmness of the foam sponge does, of course, change gradually as the temperature changes, but as is well known in the art, the degree of change and the degree of firmness or hardness of the sponge can be determined by the various ingredients.

In addition to changing firmness, the sponge pad 10 of the present invention also changes color as the temperature changes. This is accomplished by incorporating into the foam thermochromic materials which are, per se, known in the art. These are generally described in U.S. Pat. No. 6,585,555 to Wong et al. and specific examples can be found in Published Application No. US 2006/0287215 to McDonald et al. The entire disclosures of both of these documents are hereby incorporated herein by reference.

It is known to coat the outer surface of a foam product with thermochromic materials so that the outside surface can change color. This can be accomplished by printing the same thereon as described, for example, in the Wong et al. patent. The present invention, on the other hand, includes the thermochromic additives throughout the foam product. This reduces production time and costs and provides for a more uniform product.

To accomplish the foregoing, the foam for preparing a sponge pad is prepared in the normal manner. That is, the polymers and other additives, including foaming agents and the like, are prepared in the conventional manner. Before the material is allowed to foam, however, thermochromic additives are mixed in and disbursed throughout the polymer mixture. The combination is then allowed to foam and is molded or extruded utilizing any well known manufacturing technique.

Numerous and various different thermochromic additives can be utilized. The color of the sponge can change several times as the temperature changes or only a single change or other visual appearance can be selected. The choice of colors may also depend on the specific use to which the sponge is intended. All of these selections are within the scope of the invention and would be recognized by those skilled in the art.

The present invention may be embodied in other specific forms without departing from the spirit or essential attributes thereof and accordingly, reference should be made to the appended claims rather than to the foregoing specification as indicating the scope of the invention.

I claim:

1. A thermochromic foam cleaning pad comprising:
a polymer sponge foam pad;
said pad being more rigid at low temperatures and less rigid at higher temperatures, and
said pad changing its visual appearance when the temperature of the pad changes.

2. The thermochromic foam cleaning pad as claimed in claim 1 wherein the change in said visual appearance is a change in color.

3. The thermochromic foam cleaning pad as claimed in claim 2 including thermochromic particle disbursed throughout said pad.

4. The thermochromic foam cleaning pad as claimed in claim 1 wherein said pad is round and resembles a face.

5. The thermochromic foam cleaning pad as claimed in claim 4 wherein said pad has a plurality of openings passing through the body thereof.

6. A method of producing a thermochromic foam cleaning pad comprising:
mixing foamable polymers with a foaming agent;
mixing compositions with said foamable polymers that have the ability to change the rigidity of said pad with changes in temperature;
mixing thermochromic compositions with said foamable polymers;
allowing said mixture to foam and forming said foamed mixture into a cleaning pad.
